(19) United States
(12) Patent Application Publication
(10) Pub. No.: US 2025/0004468 A1
(43) Pub. Date: Jan. 2, 2025

(54) METHOD TO CONTROL A VEHICLE AS A FUNCTION OF DATA FROM A VEHICLE-BASED DRONE

(71) Applicant: FCA US LLC, Auburn Hills, MI (US)

(72) Inventors: Joydip Saha, Troy, MI (US); Scott L. Radabaugh, Rochester Hills, MI (US)

(21) Appl. No.: 18/345,359

(22) Filed: Jun. 30, 2023

(51) Int. Cl. G05D 1/00; G05D 1/02; G06V 20/17; G08G 5/00

(52) U.S. Cl. CPC G05D 1/0088; G06V 20/17; G08G 5/0026; G08G 5/0069

(57) ABSTRACT

In at least some implementations, a method of controlling a vehicle-based drone includes determining a need for secondary navigation data within a sensing area of one or more vehicle sensors, commanding the drone to depart from the vehicle, receiving at the vehicle secondary navigation data from the drone, and operating the vehicle at least in part as a function of the secondary navigation data.

### FIELD

The present disclosure relates to a method of controlling a vehicle as a function of data from a vehicle-based drone that provides feedback to the vehicle.

### BACKGROUND

Vehicle control systems may use a plurality of data sources to control a vehicle's operation or to facilitate control of the vehicle. Autonomous vehicles may utilize data from vehicle sensors and a known path of travel to a destination to control operation of vehicle along the path of travel. Autonomous vehicle operation is not possible without sufficient data by which the vehicle can control the vehicle and there are instances where additional information is needed, information sources are not operating properly or otherwise situations where operation of the vehicle would be possible or improved with additional data.

### SUMMARY

In at least some implementations, a method of controlling a vehicle-based drone includes determining a need for secondary navigation data within a sensing area of one or more vehicle sensors, commanding the drone to depart from the vehicle, receiving at the vehicle secondary navigation data from the drone, and operating the vehicle at least in part as a function of the secondary navigation data.

In at least some implementations, the method also includes determining either that: a) additional secondary navigation data is not needed; or b) that the drone needs to return to the vehicle, and commanding the drone to return to the vehicle. In at least some implementations, the determination that the drone needs to return to the vehicle is made as a function of at least one of an energy level of the drone and weather conditions experienced by the drone.

In at least some implementations, the secondary navigation data includes information about one or more of the location of roads or paths along an intended path of travel of the vehicle, and the location of one or more obstacles relative to the location of the vehicle. In at least some implementations, the method also includes commanding the drone to fly away from the vehicle to an area of interest.

In at least some implementations, the method includes providing images or video from a camera of the drone to the vehicle. In at least some implementations, the images or video includes at least a portion of the vehicle and part of the area surrounding the vehicle. In at least some implementations, the method includes displaying the images or video on a screen in the vehicle.

In at least some implementations, the secondary navigation data is communicated with a control system of the vehicle and the control system determines a path of travel of the vehicle as a function of the secondary navigation data, and the control system operates the vehicle along the path of travel. In at least some implementations, the need for secondary navigation data is determined when the vehicle is within an area that has incomplete or no primary navigation data.

In at least some implementations, the drone includes a sensor and the secondary navigation data includes signals from the sensor. In at least some implementations, information from the sensor is used to determine the size and location of objects in an intended or optional path of travel of the vehicle. Other information like, but not limited to, the color, reflectivity and any movement of an object may also be determined from information from the sensor.

In at least some implementations, a method of controlling a vehicle includes using primary navigation data to at least in part control operation of the vehicle, determining a need for secondary navigation data within a sensing area of one or more vehicle sensors to supplement, in place of or in the absence of the primary navigation data, commanding a drone carried by the vehicle to depart from the vehicle, receiving at the vehicle secondary navigation data from the drone, and operating the vehicle at least in part as a function of the secondary navigation data.

In at least some implementations, the secondary navigation data includes information about one or more of the location of roads or paths along an intended path of travel of the vehicle, and the location of one or more obstacles relative to the location of the vehicle.

In at least some implementations, the method includes commanding the drone to fly away from the vehicle to an area of interest. In at least some implementations, the method also includes providing camera data or other sensor data from the drone to the vehicle.

The drone may supplement or provided in the first instance information to the vehicle control system that may be used to assist in operation of the vehicle. Information from the drone may be used by an autonomous driving system when primary navigation is lacking or incomplete, for example, to improve the reliability and range of use of the autonomous driving system. For example, in areas where map data does not exist or where the terrain is uneven or severe, the operation of the vehicle may need to be adjusted accordingly, and information from the drone may be used to do so. Further, the information may be provided to an operator or driver of a vehicle to assist the driver with data and viewpoints not achievable from within the vehicle. Such viewpoints may be of ground at or immediately adjacent to the vehicle, of terrain ahead of the vehicle such as around a corner, within a structure (e.g. a parking lot), around a bend, over a hill, etc. Thus, the drone data may provide an improved understanding or interpretation of the vehicle surroundings for a vehicle control system or a vehicle operator.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention. Further, it is intended that the features disclosed in different implementations are combinable unless otherwise noted, or unless contradictory such that combination is not possible or does not make sense in the context of the devices and methods described.

### BRIEF DESCRIPTION OF THE DRAWINGS

FIG. 1 is a diagrammatic view of a vehicle including a drone;

FIG. 2 is a schematic diagram of a vehicle and drone and control system;

FIG. 3 is a flow chart of a method for controlling a vehicle using secondary navigation data;

FIG. 4 is a side view of a vehicle traveling over a hill;

FIG. 5 is a perspective view of a vehicle traversing rough terrain; and

FIG. 6 is a plan view of a vehicle approaching a turn with a portion of an upcoming travel path obscured.

### DETAILED DESCRIPTION

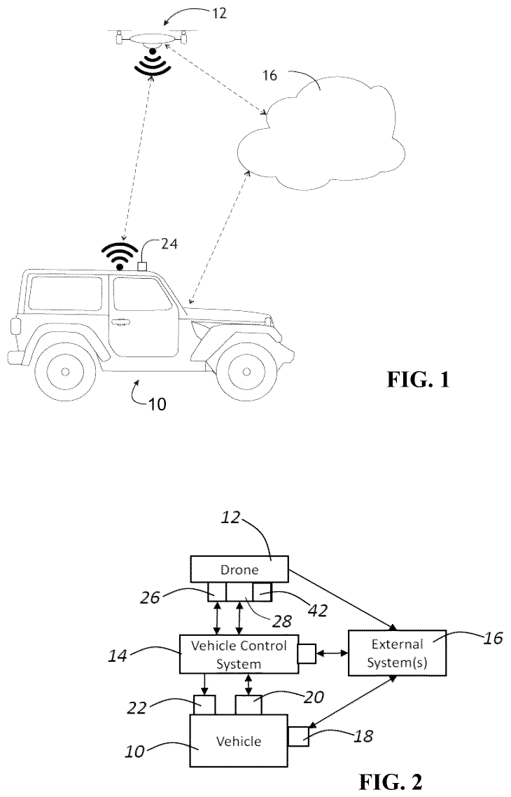

Referring in more detail to the drawings, FIG. 1 is a diagrammatic view of a vehicle 10 that travels over land and has a drone 12 that is releasably carried by the vehicle 10. The drone 12, which is an unmanned vehicle 10, may be decoupled from the vehicle 10 and may fly in the general area near the vehicle 10 as well as away from the vehicle 10 to provide information to the vehicle 10 via one or more sensors carried by the drone 12. The vehicle 10 may then be operated at least in part as a function of the information provided to the vehicle 10 by the drone 12. In the example of a vehicle 10 that may be operated autonomously (e.g. steered and advanced along a path of travel, without regard to a particular level of autonomy), one or more vehicle controllers which may be called a vehicle control system 14 may determine, as a function of the information from the drone 12, one or more of a path of travel and a rate of travel along one or more portions of the path of travel. In the example of a human controlled vehicle 10, at least some information from the drone 12 is relayed to a driver to assist the driver in navigating a desired path of travel. The information may be provided to a driver on a screen, audibly and/or by tactile feedback (e.g. vibrations in areas that may be sensed by the driver). It is understood that a vehicle 10 may operate at certain times under human control and sometimes autonomously, and that some autonomous modes involve or may permit some human interaction.

In at least some implementations, such as is diagrammatically shown in FIG. 2, the vehicle 10 has one or both of an onboard navigation system that may be part of the vehicle control system 14 and/or access to a remote system or systems 16, where the navigation systems include primary navigation data. Access or communication with remote systems 16 may occur via one or more telematics devices 18, as is known. Other sources of primary navigation data may include onboard sensors 20 of the vehicle 10, like GPS units, cameras, photoelectric or sonic sensors. The primary navigation data may relate to, for example, one or more road information and terrain information. This data may be used to one or both: 1) plot a path of travel for the vehicle 10 to a destination; and 2) operate the vehicle 10 along the path of travel according to a level of autonomy of the vehicle 10.

Primary navigation data may come from vehicle-based systems (e.g. the control system 14 and sensors 20) and remotely located systems 16. The vehicle-based systems may include controllers and sensors arranged to provide information about the location and immediate surroundings of the vehicle 10, like map data, GPS, cameras, LIDAR, RADAR and similar sensors and systems. The remotely located systems may communicate with the vehicle 10 through the telematics interface 18 and provide data to the vehicle 10 and receive data from the vehicle 10. Data provided to the vehicle 10 may include map data, road information (e.g. traffic, construction zones, hazards, and the like).

The map data may include road information such as the mapped or predetermined locations and directions of roads and paths, including grades (inclines and declines) and curves (radius or shape in general), speed limits or other regulations, and location of various points of interest like intersections, on and off ramps for highways, temporary hazards in the road (construction, pothole, object on the road, etc) whether the road includes a physical barrier or divider between roads intended for traffic moving in opposite directions, and the like. Road information may also include information about current or instantaneous density of road use (e.g. traffic) and rates of vehicle speed on one or more roads along and adjacent to the path of travel (e.g. alternate routes), as well as about predicted traffic information along the route at the expected times the vehicle 10 will be traveling along different portions of the path of travel. Primary navigation data may also include other information like weather data where icy or rainy conditions could affect road conditions, travel patterns or speeds, and may thus be factored in with or as additional road information.

Various programs/applications may be resident on a vehicle control system 14 (e.g. some combination of memory and processor(s) to execute applications and instructions) or on a device coupled to the vehicle control system 14, like a mobile device (e.g. phone or tablet or portably computer) with a wired or wireless connection to the vehicle 10, or remotely and communicated with the vehicle control system 14 and/or a mobile device via the mobile device or the telematics unit 18. Representative programs that include map data for road information, traffic information and the like, and that can determine a path of travel to a destination, are Here Map, Google Maps, Waze® and Apple Maps, of course others may be used. Weather and other information may come from one or both of an onboard vehicle sensor(s) and from a program/application including weather data, like that available from the Weather Channel® or AccuWeather®, by way of a couple examples. The primary navigation data is the information that is or might be used by a vehicle 10 in normal, daily driving, to inform and determine a path of travel to a destination and/or control a vehicle 10 along a path of travel.

In implementations including an at least somewhat autonomous vehicle 10, the vehicle control system 14 may use the primary navigation data to determine a desired path of travel to a destination, and to operate at least some vehicle drive controls to move or assist in moving the vehicle 10 along the path (e.g. accelerate, brake, and steer the vehicle 10). Vehicle drive controls 22 may include propulsion systems (engine/motor), braking systems and steering systems, that control the rate and direction of vehicle travel. The control system 14 may operate the drive controls 22 in any desired manner, including by controlled actuation of motors or other electrically controlled actuators that move one or more wheels, brakes or steering devices of the vehicle. In such implementations, the determined path of travel and vehicle control information may also be communicated to a passenger for informational purposes or to permit human intervention in the path or vehicle operation. In implementations in which a human driver controls the vehicle 10, this information may be provided to the driver to permit the driver to follow the path and to provide guidance to the driver along the path.

In at least some implementations, the vehicle 10 includes a base 24 on which the drone 12 is carried when the drone 12 is not commanded to fly away from the vehicle 10. The base 24 may include a retention mechanism to secure the drone 12 to the base, and a power supply to increase the energy level of the drone 12. For example, the drone 12 may be battery powered and the base may include an electrical connector via which power is supplied to recharge the battery when the drone 12 is connected to the base.

The drone 12 may include one or more propellers or other propulsion arrangement, suitable for unmanned flight relative to the vehicle 10. The drone 12 may fly in an untethered manner or in a tethered manner with a cable connected to the drone 12 and to the vehicle 10 (e.g. at the base). The cable/tether may limit the range of flight (and ensure the drone 12 does not become lost), provide electrical power to support the drone's flight, or both. The drone 12 may include multiple sensors, and the sensors may provide information to support flight of the drone 12 and to support operation of the vehicle 10. In this regard, the drone 12 has sensors 26 that are communicated with the vehicle control system 14, such as through a drone control system 28, to provide secondary navigation data to assist in navigation and control of the vehicle 10. And the drone 12 may also provide other information to the vehicle 10 (e.g. to permit a vehicle control system 14 to better control the drone 12, as needed). The drone control system 28 receives and conveys signals to permit operation of the drone 12 and one or more of its sensors. The drone control system may include one or more processors and memory, as well as a communication module via which the drone may receive and transmit as needed.

The secondary navigation data may include information about the environment that the vehicle 10 currently is in, including the terrain that is currently being traversed by the vehicle 10. Representative secondary navigation data may include road information such as whether a road or path exists, the type of road or path if one does exist, the location, width, grade and routing of a road or path, location and size of obstacles in the path including natural features like boulders, ruts, holes, rivers and the like. The secondary navigation data may include information about traffic conditions, temporary hazards, weather and other information collectible by or via the drone 12.

When primary navigation data is insufficient or as otherwise determined, the vehicle control system 14 or a human associated with the vehicle 10 commands the drone 12 to fly so that the drone 12 can provide secondary navigation data to the vehicle 10. The secondary navigation data could relate to areas at or near the vehicle 10, like the actual position of vehicle wheels relative to the current terrain and obstacles therein, or the drone 12 could be commanded to fly away from the vehicle 10 to provide secondary navigation data about areas remote from the vehicle 10. The drone 12 may provide information suitable for the vehicle 10 or other system to create an understanding of the area being surveyed by the drone 12, to provide positional and spatial relationships of features within area surveyed.

In at least some implementations, the secondary navigation data may be useful to help guide a vehicle 10 in situations in which one or more sources of primary navigation data are not available, or if sources of primary navigation data conflict or the vehicle control system 14 or a driver would like confirmation or determination of primary navigation data or secondary navigation data as additional information. For example, a vehicle 10 may travel in an unmapped area, that is, an area for which the source of map data is not available or is incomplete in some respect, or in an area or at a time when vehicle location information is not sufficient or available (e.g. weak or no GPS or other location signal or data reception issues), or onboard vehicle sensors 20 may be blocked (e.g. by dirt, snow, sun glare, etc), not functioning properly, or the vehicle 10 may be at an orientation in which the onboard sensors are not able to provide data they normally would (e.g. the vehicle 10 is inclined upward and forward looking sensors are then oriented at an angle where the ground ahead is not in the sensor's working area, or the vehicle is inclined in a different orientation that reduces the effectiveness of the sensors 20), or the vehicle 10 is traveling very slow, as it might over rough terrain, and the vehicle sensors do not provide a sufficient understanding of the vehicle surroundings. Further, the drone 12 can provide data to the vehicle control system 14, a driver or both, in other situations, like showing open parking spots in a parking lot or multi-level structure, providing an accurate view of construction zones or traffic jams and alternate routes, and the like.

In such instances and other instances, as desired, the vehicle control system 14 and/or a driver may command the drone 12 to depart from the base 24, to fly to one or more areas of interest and to relay secondary navigation data back to the vehicle 10. The information may be relayed directly to the vehicle 10 via a desired wired or wireless connection and communication protocol, or the information may be relayed to a remote system 16 for communication to the vehicle 10, or both. The secondary navigation data may be used by the control system 14 and/or conveyed to a driver to assist in vehicle control along an intended or desired path of travel, or to determine optional paths of travel that deviate in some way from a formerly determined path of travel.

The drone 12 may be flown to any desired area within the drone's range of travel. The drone's flight path may be chosen and the drone 12 controlled along that path autonomously, by the vehicle control system 14 or by a person. The flight path may be preset, with waypoints identified or otherwise, or the flight path may be changed as the drone 12 flies (e.g. to navigate over or around obstacles). When the need for the secondary navigation data terminates, the drone 12 may be commanded to return the vehicle 10 and the drone 12 may automatically re-dock with the vehicle 10 at the base, or the drone 12 may be manually re-docked with the vehicle 10. In certain circumstances, it may be desirable or necessary to return the drone 12 to the vehicle 10 even when a need for secondary navigation data is not terminated. This may occur, for example, when a power level of the drone 12 is too low for continued flight (e.g. remaining power is needed to return the drone 12 to the vehicle 10), or when the weather conditions are not conducive to flying the drone 12 (e.g. strong winds, rain, or the like). In such instances, the drone 12 may be commanded to return to the vehicle 10 until the conditions again permit flight of the drone 12, and if there is a continuing or new need for secondary navigation data when the conditions are suitable for drone flight.

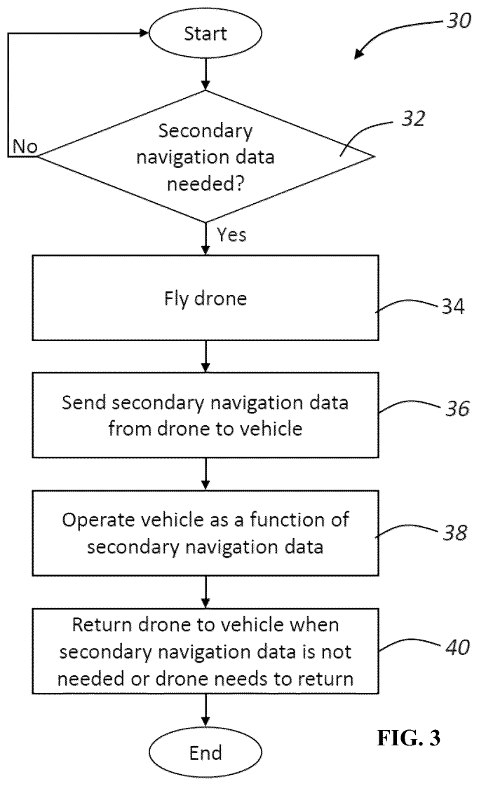

A method 30 of operating the vehicle 10 with secondary navigation data is shown in FIG. 3. In step 32, if a need for secondary navigation data is determined, the method proceeds to step 34 and the drone 12 is commanded to fly, and in step 36, secondary navigation data is sent to the vehicle 10 from the drone 12. Next, in step 38 the vehicle 10 uses at least some of the secondary navigation data to operate at least some vehicle drive control 22, or provides at least some of the secondary navigation data to a driver of the vehicle 10 for use in operating the vehicle 10, or both. Finally, in step 40, the drone 12 is returned to the vehicle 10 when secondary navigation data is no longer needed, or when the drone 12 otherwise needs to return to the vehicle 10, as described above.

Operation of the drone 12 may occur as a function of a particular type or instance of secondary navigation data that is needed or data for a particular area of interest which may be an area for which primary navigation data is incomplete. For example, the vehicle 10 may be navigating rough terrain and the drone 12 might be flown to provide an instantaneous view of an area of interest to provide information about obstacles currently being encountered by the vehicle 10, including the position of the vehicle's wheels in relation to obstacles (e.g. a real-time view of wheel position and the obstacles) to facilitate navigation over or around the obstacles. An area of interest may be any area in which the vehicle control system 14 or a person determines that additional information is needed or would be helpful for that area. In addition to including the area surrounding the vehicle 10, an area of interest may be, for example, an area not currently in view from the vehicle 10 (e.g. to the vehicle's sensors and/or occupants), like an area too far ahead to be visible, where the view is blocked by an obstruction (like a hill or a building or a decline), an overview of traffic conditions ahead, and the like.

In this disclosure, the scope of the sources of primary navigation data and secondary navigation data is intended to be broad and to include sensors 20, 26 of all types such as, but not limited to, systems that obtain information from remote sources, like GPS, map data, and instantaneous conditions like traffic information, location of construction or other temporary road hazards, as well as sources on-board the vehicle 10 like sensors using light of any wavelength(s) like a camera or various types of photoelectric sensors, and sensors using sound waves like ultrasonic sensors, and sonar, radar and lidar are representative examples.

Beyond secondary navigation data, the drone 12 may include operational sensors 42 to, among other things, provide information to a drone 12 control system to facilitate control of the drone 12. Such sensors 42 may include object detection sensors arranged to prevent the drone 12 from flying into an obstruction, a wind sensor that may determine wind speeds to help in controlling the drone 12 or determining that the wind is beyond a threshold for satisfactory drone 12 flying, a GPS or other location system to provide an indication of the drone's location, information about a preplanned path of travel for the drone 12, a sensor indicating the drone's altitude, a camera to provide data or imagery (still images or video) of the drone's location and path ahead, and the like. This information may be used to assist automated or user control of the drone 12. Information about the drone's location (3D position including height) may also be useful in combination with some secondary navigation data to facilitate determination of distances and sizes of objects, for example. Further, data from the vehicle sensors could be used by the drone control system (in addition to drone mounted sensors) to prevent the drone from flying into objects or hazards.

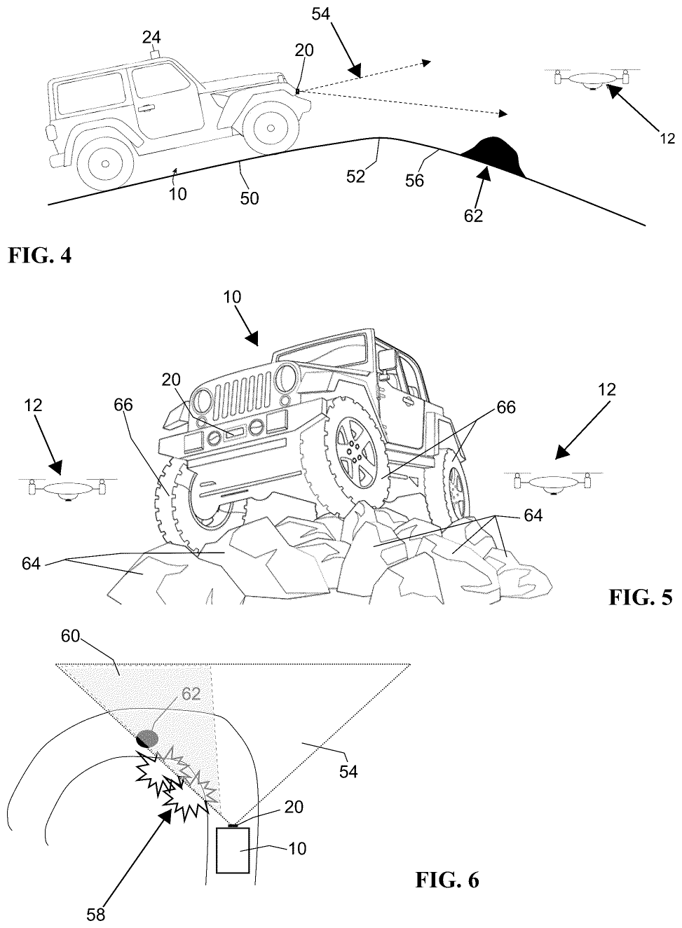

As noted above, and as shown in FIGS. 4-6, the drone 12 may be used to provide feedback to the vehicle control system 14, a driver, or both, with regard to terrain near the vehicle to aid in navigating this nearby terrain. That is, one or more the vehicle sensors 20 may provide primary navigation data with regard to nearby terrain in certain operating conditions, and when such primary navigation data is not available, the drone 12 may be deployed to provide secondary navigation data.

FIG. 4 illustrates an example in which the vehicle 10 is travelling up an incline 50, and is near a peak 52 of the incline. In this orientation or the vehicle 10, the forward-facing sensors 20, which may include but are not limited to a camera, have a sensing area 54 (e.g. a field of view of a camera) that is oriented upward relative to a flat area (e.g. the top of the peak 52) and/or relative to a decline 56 the follows the peak. In at least some circumstances, the sensing area 54 does not include the peak 52 or decline surface 56 and so the vehicle does not have information about the upcoming terrain at the peak and on the decline surface. Similarly, nearby terrain can be obscured by a turn in the path, as shown in FIG. 6, with or without an incline or decline, and, for example with a wall, ground (e.g. side of a hill), tree or other object or objects 58 between the vehicle onboard sensors 20 and the nearby area inhibiting or preventing sensing of at least part of the upcoming, nearby terrain, as shown by the shaded area 60. This may occur even when the obscured nearby terrain 60, and an obstacle/hazard 62 therein, is within a normal sensing area 54 of one or more sensors 20 (i.e. within a maximum distance and angle range of one or more of the sensors) but the obstacle 58 is in the way, as shown in FIG. 6. In such situations, the drone 12 may be employed to provide feedback regarding the nearby, upcoming terrain.

In the example shown in FIG. 4, an obstacle/hazard 62 exists on the decline surface 56 within a distance from the vehicle 10 that would normally be detectable by one or vehicle sensors 20, but the obstacle is outside of the sensing area of the vehicle sensors/cameras 20 in that location of the vehicle. In other words, it isn't that the obstacle 62 is too far away from the vehicle 10 to be sensed or detected, but the vehicle sensors 20 cannot sense or detect the obstacle 62 because of an object in the way or in between (where the hill in the example of FIG. 4 is an object). In instances in which the vehicle 10 is traveling at a rate of speed that makes steering around the obstacle 62 difficult if such steering occurs when the vehicle is close to the obstacle (in the example of FIG. 4, only after the vehicle has crested the peak 52 and is on the decline 56), the vehicle 10 may either hit the obstacle 62 or need to make a sudden, sharp turn to try and avoid all or part of the obstacle. With feedback from the drone 12 while the vehicle 10 is still sufficiently far from the obstacle 62, however, maneuvering of the vehicle can be accomplished sooner to better navigate the decline surface 56 and obstacles 62 thereon, where such maneuvering may include both steering and speed control prior to the obstacle being detected by the vehicle sensors 20.

The feedback may include information (e.g. video/images) of the nearby terrain and that information may include the terrain by itself or it may include the position of the vehicle 10 relative to the nearby terrain. That is, the vehicle or part of the vehicle may be within the sensing area of the drone 12, for example, part of the vehicle 10 may be within a field of vision of a camera of the drone 12. The feedback is usable by the control system 14 or the driver, or both, to navigate the vehicle 10 over the nearby terrain, and/or to determine if the vehicle 10 may be navigated over the nearby terrain where in some instances the upcoming terrain may be too severe for the vehicle to traverse, requiring a different path of travel to be determined and followed.

In FIG. 5, the vehicle 10 is shown navigating large boulders 64 or similar uneven terrain. The particular path of the vehicle 10 relative to the specific boulders 64 or other obstacles/uneven surface features (e.g. stumps, craters, ruts, etc) may be important for successfully traversing the terrain. In this example, the drone 12 may be deployed to provide direct feedback of the position of the vehicle 10 relative to the terrain on which the vehicle is currently located and some upcoming, nearby terrain ahead of the vehicle in the vehicle's path of travel. More specifically, the drone 12 may be positioned as desired around the outside of the vehicle 10 and, at least in some instances, the drone may provide a video feed of the position of one or more vehicle wheels 66 to enable more precise control of the vehicle path of travel and the specific area that the vehicle wheel(s) 66 roll over as the vehicle moves. That is, the drone 12 may show at least part of an obstacle 62, 64 that the vehicle is to drive over or around, and part of a vehicle wheel 66 as the wheel 66 rolls over or around the obstacle 62, 64. This may facilitate precise positioning of one or more wheels 66 relative to one or more obstacles. The drone 12 may provide feedback regarding one wheel 66 or more than one wheel 66, as desired. This direct visual guidance can provide real-time feedback to the vehicle control system 14 or driver, or both, to facilitate maneuvering the vehicle 10 over the uneven terrain.

In FIG. 5, the drone 12 is shown in two, representative positions. The drone 12 may be positioned at different altitudes or heights, and at different distances and fore-aft locations relative to the vehicle 10 or part of the vehicle, including with a view at least partially beneath the vehicle, or with part or all of the drone 12 under part of the vehicle 10, as desired. The drone 12 may remain in the same general location relative to the outside terrain (e.g. the vehicle moves relative to the drone), or the drone 12 may move relative to the vehicle 10, or the drone 12 may stay in the same general location with respect to the vehicle 10 by moving at the same general rate as the vehicle, for all or part of the vehicle's movement over a given area. The drone 12 can also provide images or video of portions of the underbody of the vehicle and/or the vehicle wheels, to, among other things, show clearance of the vehicle relative to one or more objects, or to permit inspection of areas or components under the vehicle (e.g. to determine if some part of the vehicle has been damaged). Further, while shown as providing imagery to help navigate over objects, the drone could also show clearance of the vehicle sides relative to objects and/or the roof as the vehicle drives beneath an object (e.g. a tree limb).

In at least some implementations, the drone 12 is commanded to fly to provide navigation data in an area that includes the vehicle, and in a nearby area that is at a distance that would be within a sensing area of one or more vehicle sensors 20 but due to an object, is not detectable by the vehicle sensors 20. That is, the nearby area is within the distance range of one or more vehicle sensors 20, but at least part of the area is obscured from the sensors by one or more objects between the vehicle and a nearby area of the path of travel. Such objects could be trees, rocks, a hill or a wall, etc, that orients, obscures or blocks the vehicle sensors 20 such that features or data about a nearby area is not detectable by the vehicle sensors 20.

Further, secondary data may be needed in an area that was within a sensing area of one or more sensors 20 before the vehicle 10 was in that area, and for which real-time information is helpful to navigation of the vehicle on a particular portion of the path on which the vehicle 10 is located, to get the vehicle around or over obstacles currently being encountered by the vehicle. In one example, the area was not blocked by an object when the vehicle was at a distance from the area, but the area is now outside the sensing area of the vehicle sensors because the vehicle currently is on top of that area and the vehicle sensors 20 have a forward projected sensing area. Additionally, the back side of an obstacle, or things behind an obstacle that is within the sensing area might not be detected by the sensors 20 and so secondary navigation data may be needed to see behind or the back side of obstacles like rocks, stumps, or the like.

The vehicle/drone system enables a method of operation of the vehicle 10 equipped with a drone 12 that has one or more sensors 26 or systems that provide secondary navigation data to a vehicle 10 that may include information obtained from perspectives and views not obtainable by vehicle mounted sensors 20 and systems, including, for example, views around blockages or obstructions, views of terrain above/below vehicle sensor area or field of view. Thus, the information my relate to not only road information like the presence or a road or path, but the particular terrain of the road, path or area being traversed by the vehicle 10 including the location(s) of obstacles relative to the vehicle 10, both in a static manner and as the vehicle moves through the terrain, as desired. This collaborative approach for vehicle control can improve or extend autonomous driving options and adds advantages over vehicle mounted sensors.

The vehicle control system can use the secondary navigation data to precisely calculate an intended path of travel for the vehicle that may include one or more waypoints that may be selected at least in part based upon the secondary navigation data. The drone and the secondary navigation data can help the vehicle navigate or be navigated through complicated surface like the paths with large rocks (e.g. as in Moab, Utah). Similarly, if the vehicle is stuck in a construction zone, behind a traffic accident or otherwise in traffic, the vehicle can request the drone to fly and provide a bird's eye view of the scenario to determine waypoints that it can autonomously follow or that may be plotted for a driver to follow. For underground parking or other parking structures or parking lots whether on multiple levels or a single level, the drone can be flown to provide view of parking spaces and further looking waypoints without requiring other sensors like LIDAR.

What is claimed is:

1. A method of controlling a vehicle-based drone, comprising:
determining a need for secondary navigation data within a sensing area of one or more vehicle sensors;
commanding the drone to depart from the vehicle;
receiving at the vehicle the secondary navigation data from the drone; and
operating the vehicle at least in part as a function of the secondary navigation data.

2. The method of claim 1 which also includes:
determining either that: a) additional secondary navigation data is not needed; or b) that the drone needs to return to the vehicle; and
commanding the drone to return to the vehicle.

3. The method of claim 2 wherein the determination that the drone needs to return to the vehicle is made as a function of at least one of an energy level of the drone and weather conditions experienced by the drone.

4. The method of claim 1 wherein the secondary navigation data includes information about one or more of the location of roads or paths along an intended path of travel of the vehicle, and the location of one or more obstacles relative to the location of the vehicle.

5. The method of claim 1 which also includes commanding the drone to fly away from the vehicle to an area of interest.

6. The method of claim 1 which also includes providing images or video from a camera of the drone to the vehicle, where the images or video includes at least a portion of the vehicle and part of a terrain near the vehicle or on which the vehicle is located.

7. The method of claim 6 wherein the method includes displaying the images or video on a screen in the vehicle.

8. The method of claim 6 wherein the portion of the vehicle includes at least one wheel of the vehicle.

9. The method of claim 1 wherein the secondary navigation data is communicated with a control system of the vehicle and the control system determines a path of travel of the vehicle as a function of the secondary navigation data, and the control system operates the vehicle along the path of travel.

10. The method of claim 1 wherein the need for secondary navigation data is determined when the vehicle is within an area that has incomplete or no primary navigation data.

11. The method of claim 1 wherein the drone includes a sensor and the secondary navigation data includes signals from the sensor.

12. The method of claim 11 wherein the sensor data is used to determine the size and location of objects in an intended or optional path of travel of the vehicle.

13. A method of controlling a vehicle, comprising:
using primary navigation data to at least in part control operation of the vehicle;
determining a need for secondary navigation data within a sensing area of one or more vehicle sensors to supplement, in place of or in the absence of the primary navigation data;
commanding a drone carried by the vehicle to depart from the vehicle;
receiving at the vehicle secondary navigation data from the drone; and
operating the vehicle at least in part as a function of the secondary navigation data.

14. The method of claim 13 wherein the secondary navigation data includes information about one or more of the location of roads or paths along an intended path of travel of the vehicle, and the location of one or more obstacles relative to the location of the vehicle.

15. The method of claim 13 which also includes commanding the drone to fly away from the vehicle to an area of interest.

16. The method of claim 1 which also includes providing camera data from a camera of the drone to the vehicle.

17. The method of claim 13 wherein the secondary navigation data is communicated with a control system of the vehicle and the control system determines a path of travel of the vehicle as a function of the secondary navigation data, and the control system operates the vehicle along the path of travel.

18. The method of claim 13 wherein the need for secondary navigation data is determined by a vehicle control system when the vehicle is within an area that has incomplete or no primary navigation data.

19. The method of claim 13 wherein the drone includes a sensor and the secondary navigation data includes signals from the sensor.

20. The method of claim 13 wherein the need for secondary navigation data is determined by a vehicle control system when the vehicle is within an area that has incomplete or no primary navigation data and is within a range of a sensing area of one or more vehicle sensors but for which the vehicle sensors do not provide primary navigation data.
